(19) United States
(12) Patent Application Publication
(10) Pub. No.: US 2023/0169561 A1
(43) Pub. Date: Jun. 1, 2023

(54) SYSTEMS AND METHODS FOR AUTOMATICALLY EXTRACTING INFORMATION FROM TEXT DATA

(71) Applicant: The Florida State University Research Foundation, Inc., Tallahassee, FL (US)

(72) Inventors: Herman Autore, Tallahassee, FL (US); Adrian Barbu, Tallahassee, FL (US)

(21) Appl. No.: 18/072,089

(22) Filed: Nov. 30, 2022

Related U.S. Application Data
(60) Provisional application No. 63/284,160, filed on Nov. 30, 2021.

(51) Int. Cl. G06Q 30/0601

(52) U.S. Cl. CPC G06Q 30/0625

(57) ABSTRACT

Systems and methods for automatically extracting information from text data are described herein. The systems and methods can be used to create a data repository, for example, a data repository that stores respective product-information records for a plurality of products. Optionally, the data repository can be used by a structured search engine for products.

### CROSS-REFERENCE TO RELATED APPLICATIONS

This application claims the benefit of U.S. provisional patent application No. 63/284,160, filed on Nov. 30, 2021, and titled “SYSTEMS AND METHODS FOR AUTOMATICALLY EXTRACTING INFORMATION FROM TEXT DATA,” the disclosure of which is expressly incorporated herein by reference in its entirety.

### BACKGROUND

The world is facing an obesity and diabetes epidemic, with 34% of the adults being obese in the United States. People that try to lose weight face many challenges and obstacles, including misleading advertising from the food manufacturers. Some foods are advertised as “low fat” but actually are loaded with sugar, another others are “carb smart”, but they are full of fat. It is hard to make an informed decision in this environment where nothing is as advertised. There might be some good honest foods out there, but they are hard to find in this sea of misinformation. It is not enough that customers have the product information on various websites (one website for each product), because one has to spend a considerable amount of time to collect and compile all relevant information to find the product that best fits one's needs.

### SUMMARY

Systems and methods for automatically extracting information from text data are described herein. The systems and methods can be used to create a data repository, for example, a data repository that stores respective product-information records for a plurality of products. Optionally, the data repository can be used by a structured search engine for products.

According to one aspect, the present disclosure relates to a method. The example method includes extracting text data associated with a product, where the text data comprises a plurality of text strings; detecting one or more keywords within the text strings; detecting one or more numerical values within the text strings; constructing, using a hierarchical model, a product-information record for the product from the one or more detected keywords and the one or more detected numerical values; and storing the product-information record for the product in a data repository.

In some implementations, the product is a food product.

In some implementations, the text data comprises at least one of a product name, a product manufacturer, or a plurality of product attributes.

In some implementations, the plurality of product attributes are nutritional attributes.

In some implementations, the nutritional attributes comprise at least one of calories, total fat, saturated fat, sugar, sodium, or protein.

In some implementations, the step of detecting the one or more keywords within the text strings comprises using a string parsing method.

In some implementations, the step of detecting the one or more keywords within the text strings comprises representing the one or more keywords in a high-dimensional space and searching the high-dimensional space.

In some implementations, the hierarchical model is a generative model.

In some implementations, the hierarchical model is a discriminative model.

In some implementations, the method further includes assigning, using dynamic programming, a respective numerical value to a respective keyword.

In some implementations, the method further includes associating, using a classifier model, the product-information record for the product with one of a plurality of product categories.

In some implementations, the classifier model is a support vector machine (SVM), an artificial neural network (ANN), a boosted decision tree (DT), or a random forest (RF).

In some implementations, the text data is obtained from a product website.

In some implementations, the text data is obtained from a product package using computer vision.

According to another aspect, the present disclosure relates to a method. The method includes maintaining a data repository comprising a plurality of product-information records, where the data repository is created according to any of the methods described herein; and querying the data repository for a product or a product attribute.

According to another aspect, the present disclosure relates to a system. The example system includes a processor; and a memory operably coupled to the processor, the memory having computer-executable instructions stored thereon that, when executed by the processor, cause the processor to: extract text data associated with a product, where the text data comprises a plurality of text strings; detect one or more keywords within the text strings; detect one or more numerical values within the text strings; construct, using a hierarchical model, a product-information record for the product from the one or more detected keywords and the one or more detected numerical values; and store the product-information record for the product in a data repository.

In some implementations, the step of detecting the one or more keywords within the text strings comprises: using a string parsing method; or representing the one or more keywords in a high-dimensional space and searching the high-dimensional space.

In some implementations, the hierarchical model is a generative model or a discriminative model.

In some implementations, the memory has further computer-executable instructions stored thereon that, when executed by the processor, cause the processor to assign, using dynamic programming, a respective numerical value to a respective keyword.

In some implementations, the memory has further computer-executable instructions stored thereon that, when executed by the processor, cause the processor to associate, using a classifier model, the product-information record for the product with one of a plurality of product categories.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 is an example user interface used to search for food products based on specific nutritional constraints according to an implementation described herein.

FIG. 2 illustrates example text strings associated with a food product.

FIG. 3 illustrates an example process of extracting nutritional attributes and values from a text string.

FIG. 4 illustrates dependencies between keywords and numerical values for nutritional attributes using a knowledge extraction algorithm according to an example described herein.

FIG. 5 illustrates how the hierarchical model depends on a division of nutrition strings into substrings associated with fields of interest and includes separate models for each substring according to an example described herein.

FIG. 6 illustrates construction of a nutritional attribute information according to an example described herein.

FIG. 7 illustrates detected keywords, numerical values, and division of candidates according to an example described herein.

FIG. 8 illustrates how division of a text string into substrings uniquely associates numerical values to keywords according to an example described herein.

FIG. 9 is an example computing device.

FIG. 10 illustrates a method for creating a product information record and storing the product information record in a data repository, according to an example described herein.

FIG. 11 illustrates a method of querying a data repository for a product or product attribute, according to an example described herein.

FIG. 12 illustrates a knowledge extraction algorithm, according to an example described herein.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The term “artificial intelligence” is defined herein to include any technique that enables one or more computing devices or comping systems (i.e., a machine) to mimic human intelligence. Artificial intelligence (AI) includes, but is not limited to, knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that enables a machine to automatically discover representations needed for feature detection, prediction, classification, etc. using layers of processing. Deep learning techniques include, but are not limited to, artificial neural network or multilayer perceptron (MLP).

Machine learning models include supervised, semi-supervised, and unsupervised learning models. In a supervised learning model, the model learns a function that maps an input (also known as feature or features) to an output (also known as target or targets) during training with a labeled data set (or dataset). In an unsupervised learning model, the model learns patterns (e.g., structure, distribution, etc.) within an unlabeled data set. In a semi-supervised model, the model learns a function that maps an input (also known as feature or features) to an output (also known as target or targets) during training with both labeled and unlabeled data.

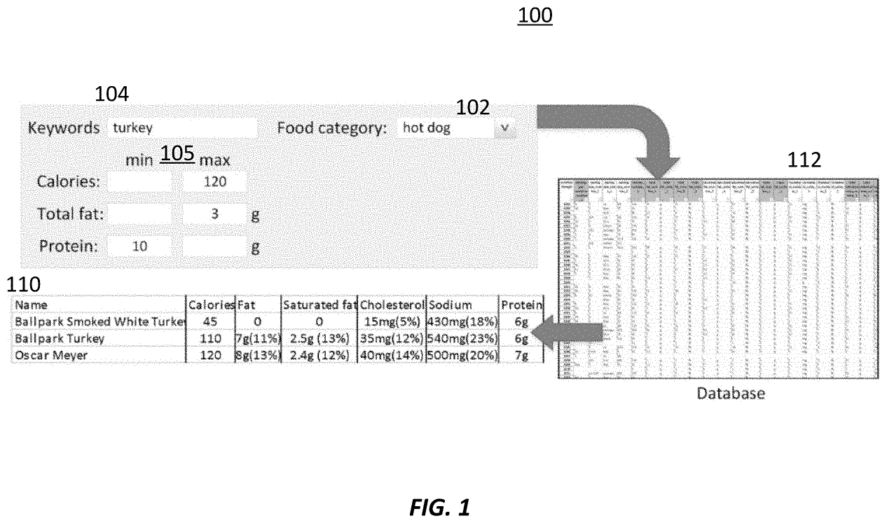

In the example implementations described herein, the product is a food product. The systems and methods described herein aim to put the power back into the hands of the consumer, offering a search engine where the consumer can instantly query for a specific type of food (e.g. hot dogs) and obtain the products returned by the query in a table. An example table 110 and web interface 100 is shown in FIG. 1. In the table 110 of FIG. 1 each product (e.g., Ballpark Smoked White Turkey, Ballpark Turkey, Oscar Meyer) is a row, with their relevant nutritional information such as: calories, fat, saturated fat, cholesterol, sodium, and protein as columns. There is a small and finite number of products of a certain type out there, and the systems and methods described herein access each product website from its manufacturer and extract the relevant information about it to fill in the row in the table. It should be understood that food products are provided only as an example. This disclosure contemplates that the product can be other types of products including, but not limited to, drugs, appliances (e.g., vacuum cleaners, TVs), power tools, or other products with technical specifications. Additionally, it should be understood that the types of nutritional information are provided only as an example. This disclosure contemplates that the nutritional information can be other types of information including, but not limited to, carbohydrate, sugar, vitamin, mineral, or other nutritional information.

Still with reference to FIG. 1, the interface can have a drop-down menu 102 for the food categories and can also have a text box 104 where the user can enter keywords that should be present in the product name or brand. The nutrition values can be restricted through several min or max boxes 105. What nutrition value(s) are to be restricted can be chosen from a drop-down menu (not shown).

The returned entries can be displayed as a table 110 and sorted by the desired field (e.g., by protein in decreasing order). FIG. 1 also illustrates an example section of a database 112 that can be queried.

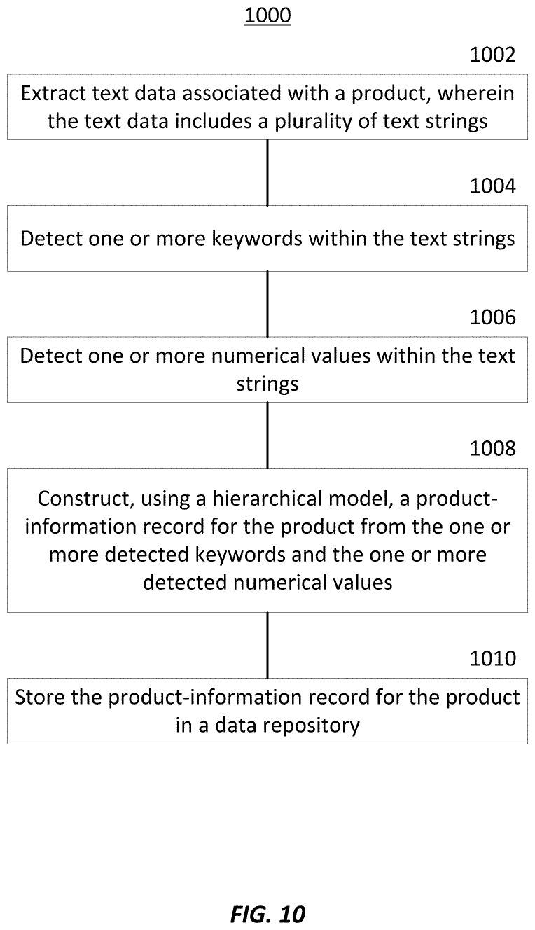

An example method for automatically extracting information from text data is described below. For example, a method 1000 is shown in FIG. 10. At step 1002, text data is extracted. In the example implementation, the text data is associated with a product and includes a plurality of text strings. Optionally, the text data is associated with a product, e.g., a food product in the example below. The text data includes at least one of a product name, a product manufacturer, and/or a plurality of product attributes. For example, the plurality of product attributes for a food product can include, but are not limited to, nutritional attributes such as calories, total fat, saturated fat, sugar, sodium, or protein. It should be understood that the nutritional attributes provided above are only examples and that the product attributes can include other food product information. In the example below, the text data is obtained from a product website. It should be understood that extracting text data from a product website is only provided as an example. This disclosure contemplates extracting text data from other sources including, but not limited to, a product package using computer vision.

This disclosure contemplates that the knowledge extraction technique described herein is flexible enough to parse any product website and extract the nutrition information to store it in the data repository. Conventional language models cannot accomplish these tasks. The knowledge extraction technique described herein makes such a task feasible, for example, because the scope can be constrained (e.g., limited to nutrition information strings and pictures of nutrition information labels), with most of the fields having only a small number of relevant words and with the nutrition values in a restricted range. Even so, there are still many challenges since the same information can be conveyed using different units of measure (e.g. grams, milligrams, or ounces), and there can be missing fields (e.g. missing information) and/or extra text (e.g. describing how a serving is obtained) that is not needed. The systems and methods described herein address these challenges.

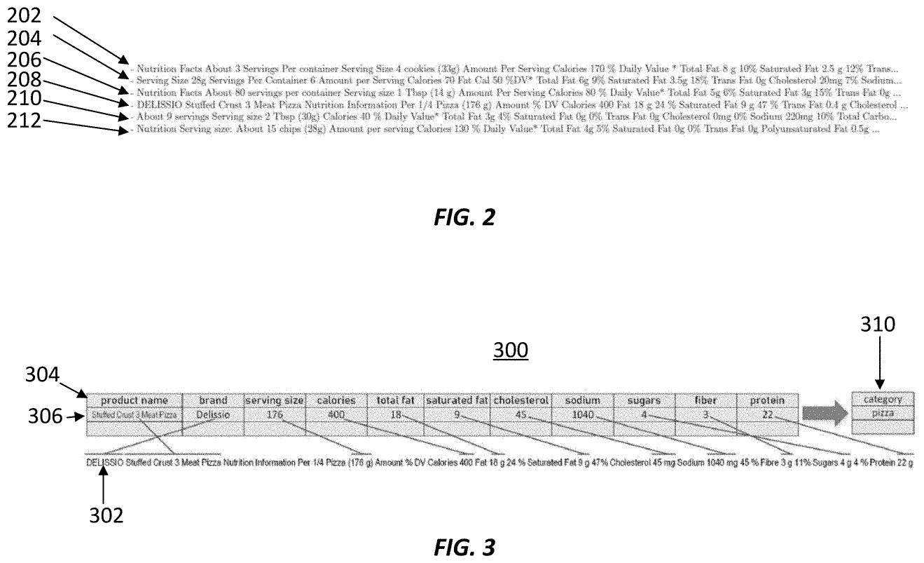

The method includes extracting text data associated with a food product (e.g., hot dogs). As described herein, the text data includes a plurality of text strings. FIG. 2 illustrates example text strings 202, 204, 206, 208, 210, 212 associated with an example food product. As described herein, the text data in the example text strings 202, 204, 206, 208, 210, 212 is obtained from the food product's website. The text data, which includes product names, product manufacturers, nutritional information, etc., may appear in various places, fonts, formats, etc. on the website. Additionally, text data associated with different products (i.e., found on different websites) also may appear in various places, fonts, formats, etc. This makes extraction and/or parsing of relevant data a difficult task.

Still with reference to FIG. 10, the method 1000 can further include detecting one or more keywords within the text strings at step 1004. The keywords are sometimes referred to herein as “substrings.” Keywords include, but are not limited to, product names, product manufacturers, and nutritional information. In some implementations, the step 1004 of detecting the one or more keywords within the text strings includes using a string parsing method. In other implementations, the step 1004 of detecting the one or more keywords within the text strings includes representing the one or more keywords in a high-dimensional space and then searching the high-dimensional space.

Again with reference to FIG. 10, the method 1000 can further include detecting one or more numerical values within the text strings at step 1006. Optionally, this can be accomplished by substrings containing digits 0-9. Optionally, the method further includes detecting units of measure (e.g., grams, ounces, milliliters, etc.) associated with the numeric values. This is optionally accomplished by detecting substrings in proximity (e.g., immediately following) the numeric values.

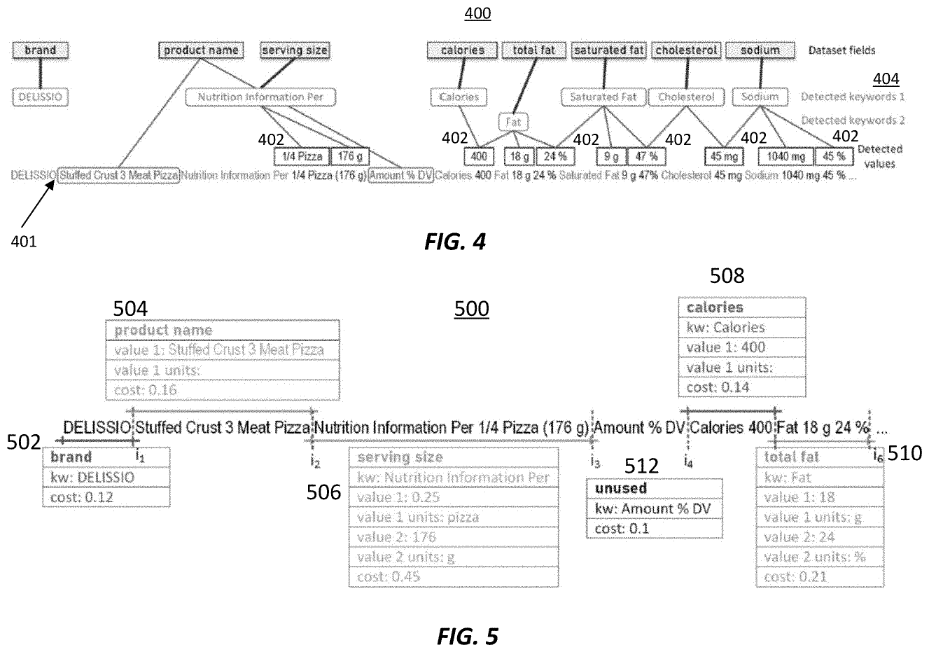

As shown in FIG. 10, the method 1000 can also include constructing, using a hierarchical model, a product-information record for the product from the one or more detected keywords and the one or more detected numerical values at step 1008. An example implementation of this process is shown in FIGS. 4-8. It should be understood that a plurality of hierarchical models can be used, e.g., a model for each of a plurality of keywords or substrings. In some implementations, the hierarchical model is a generative model. In some implementations, the hierarchical model is a discriminative model. Alternatively or additionally, the method includes assigning, using dynamic programming, a respective numerical value to a respective keyword.

Still with reference to FIG. 10, the method 1000 can include storing the product-information record for the product in a data repository (e.g., a database) at step 1010. Optionally, as described herein, the respective product-information record for each product is stored in a row with the columns storing product names, product manufacturers, nutritional information, etc.

Optionally, in some implementations, the method further includes associating, using a classifier model, the product-information record for the product with one of a plurality of product categories. Food product categories can include, but are not limited to, pizza, hot dogs, bread, milk, and cereal. Example classifier models include a support vector machine (SVM), an artificial neural network (ANN), a boosted decision tree (DT), and a random forest (RF). It should be understood that SVM, ANN, boosted DT, and RF are provided only as example classifier models. This disclosure contemplates using other multiclass classifier models.

An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as input layer, output layer, and optionally one or more hidden layers. An ANN having hidden layers can be referred to as deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tan H, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A support vector machine (SVM) classifier is a supervised classification model based on statistical learning framework. SVM models can be used for classification or regression analysis. SVM models are trained with a data set to map new samples to one of a plurality of categories. SVM models are known in the art and are therefore not described in further detail herein.

A random forest (RF) classifier is a supervised classification model including a plurality of decision trees (e.g. an ensemble). RF models can be used for classification or regression analysis. During training, each of the decision trees is trained on a different part of the same data set. The RF classifier's final prediction (e.g., class label) is the one predicted most frequently by the member decision trees. The objective is to predict a class label that is more accurate than the prediction of an individual decision tree. RF classifiers are known in the art and are therefore not described in further detail herein.

A boosted decision tree (DT) classifier is a supervised classification model including a plurality of decision trees (e.g. an ensemble). Boosted DT models can be used for classification or regression analysis. In contrast to RF classifiers, each decision tree in the ensemble of a boosted DT classifier is dependent on one or more prior decision trees. Boosted DT classifiers are known in the art and are therefore not described in further detail herein.

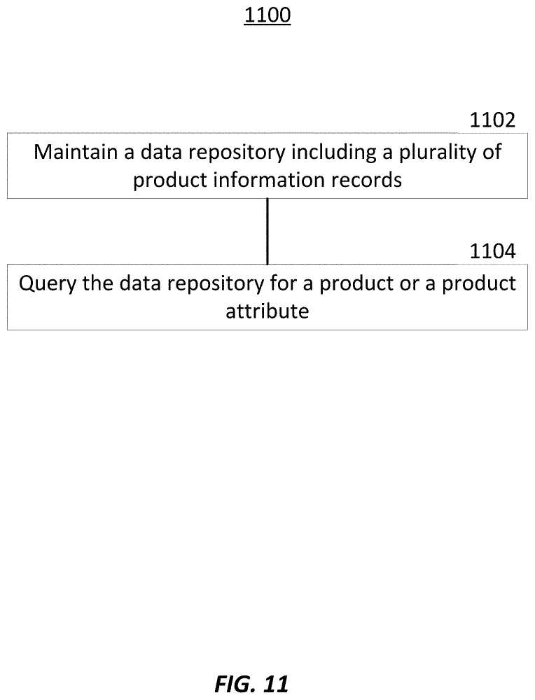

Optionally, in some implementations, the method 1000 illustrated in FIG. 10 further includes maintaining a data repository comprising a plurality of product-information records; and querying the data repository for a product or a product attribute. FIG. 11 illustrates an example method 1100, where at step 1102 a data repository is maintained including a plurality of product information records, and at step 1104 the data repository is queried for a product attribute. It should be understood that the data repository maintained at step 1102 in FIG. 11 can be a data repository generated using any of the implementations of the method described herein, including method 1000 described with reference to FIG. 10. In some implementations, the database maintained at step 1102 is a web-based database, and querying the database at step 1104 includes using a web-based interface. For example, the present disclosure contemplates running food product queries using a web-based interface. Such a search engine allows a user to enter specific search constraints (e.g., product type, nutritional information, etc.) and retrieve only the products satisfying such constraints. An example user interface is shown in FIG. 1.

Example Computing Device

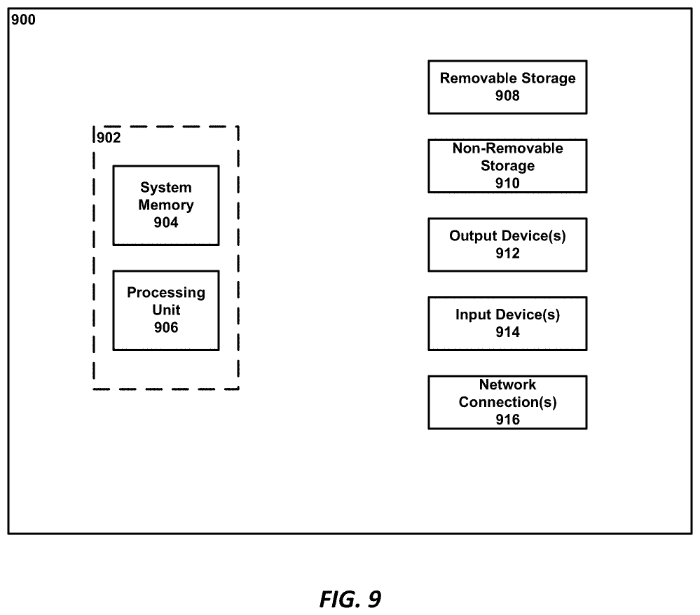

It should be appreciated that the logical operations described herein with respect to the various figures may be implemented (1) as a sequence of computer implemented acts or program modules (i.e., software) running on a computing device (e.g., the computing device described in FIG. 9), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 9, an example computing device 900 upon which the methods described herein may be implemented is illustrated. It should be understood that the example computing device 900 is only one example of a suitable computing environment upon which the methods described herein may be implemented. Optionally, the computing device 900 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 900 typically includes at least one processing unit 906 and system memory 904. Depending on the exact configuration and type of computing device, system memory 904 may be volatile (such as random access memory (RAM)), non-volatile (such as read-only memory (ROM), flash memory, etc.), or some combination of the two. This most basic configuration is illustrated in FIG. 9 by dashed line 902. The processing unit 906 may be a standard programmable processor that performs arithmetic and logic operations necessary for operation of the computing device 900. The computing device 900 may also include a bus or other communication mechanism for communicating information among various components of the computing device 900.

Computing device 900 may have additional features/functionality. For example, computing device 900 may include additional storage such as removable storage 908 and non-removable storage 910 including, but not limited to, magnetic or optical disks or tapes. Computing device 900 may also contain network connection(s) 916 that allow the device to communicate with other devices. Computing device 900 may also have input device(s) 914 such as a keyboard, mouse, touch screen, etc. Output device(s) 912 such as a display, speakers, printer, etc. may also be included. The additional devices may be connected to the bus in order to facilitate communication of data among the components of the computing device 900. All these devices are well known in the art and need not be discussed at length here.

The processing unit 906 may be configured to execute program code encoded in tangible, computer-readable media. Tangible, computer-readable media refers to any media that is capable of providing data that causes the computing device 900 (i.e., a machine) to operate in a particular fashion. Various computer-readable media may be utilized to provide instructions to the processing unit 906 for execution. Example tangible, computer-readable media may include, but is not limited to, volatile media, non-volatile media, removable media and non-removable media implemented in any method or technology for storage of information such as computer readable instructions, data structures, program modules or other data. System memory 904, removable storage 908, and non-removable storage 910 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 906 may execute program code stored in the system memory 904. For example, the bus may carry data to the system memory 904, from which the processing unit 906 receives and executes instructions. The data received by the system memory 904 may optionally be stored on the removable storage 908 or the non-removable storage 910 before or after execution by the processing unit 906.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

### Examples

The following examples are put forth so as to provide those of ordinary skill in the art with a complete disclosure and description of how the compounds, compositions, articles, devices and/or methods claimed herein are made and evaluated, and are intended to be purely exemplary and are not intended to limit the disclosure. Efforts have been made to ensure accuracy with respect to numbers (e.g., amounts, temperature, etc.), but some errors and deviations should be accounted for.

An example implementation of the present disclosure is described herein. The example implementation includes a search engine that enables the public to search for food products based on any desired nutrition criteria. The search engine can be based on a database of millions of food products from hundreds of manufacturers, organized in a table, where each product is a row with its nutrition values as columns. The search engine can allow users to search for food products that satisfy their specific dietary constraints. For each user query, the engine can extract from the database the products that satisfy the user's criteria and return them sorted in the desired order. Implementations of the present disclosure can include any or all of the following features:

1. A knowledge extraction algorithm that can automatically retrieve for each food product the desired nutrition information such as calories, saturated fat, sodium content, etc., as well as the product name and the product manufacturer. These elements can be extracted from the product manufacturer's website, which can include an individual web page for each of their food products and can be added to a database.

2. Using the knowledge extraction algorithm to collect the nutrition information for a large number (on the order of hundreds of thousands to millions) of food products and storing them in a database.

3. A classification algorithm to organize the food products into a small number of food categories. Some non-limiting examples of food categories include pizza, hot dogs, ice-cream, bread, etc. It should be understood that the preceding food categories are only examples, and that any group of categories can be used for implementations of the present disclosure. Implementations of the present disclosure can also automatically predict for each food product the respective food category or categories that food product belongs to.

4. A server with a public web interface that can allow the user (including the general public) to run nutrition-constrained searches on the database and retrieve the products from any food category that satisfy the user's dietary constraints.

5. Education for users (e.g., the public) on basic nutrition concepts to help them develop healthy eating habits and to better use this food search engine to improve their health.

The example implementation described herein can be highly relevant to the US public because of the growing obesity epidemic (from 30.5% in 2000 to 42.4% in 2018) and its related increases in healthcare costs and degradation in the quality of life. Many people would like to lose weight but have a hard time finding the right foods for their needs. The search for the right food is hampered by the marketing tactics employed by the manufacturers, who advertise the positive aspects of a food product while hiding the negatives. As a non-limiting example, a box of ice cream is advertised as low-fat, but at the same time, it is full of sugar, or vice-versa. Users can benefit from a search engine that can search for any desired food category (e.g. pizza) and return only the products that fit a user's specific dietary needs.

A main challenge in building such a food search engine can be constructing a food product database containing most of the products available on the market, almost entirely automatically. Crowd-sourced databases and databases created through manual data entry can be subject to data quality issues such as unreliable values, duplicate entries, etc. Moreover, the access to conventional crowd-sourced databases is rudimentary and one cannot perform complex searches with multiple constraints.

The example implementation described herein can automatically extract the nutritional information from the product manufacturer's websites since each manufacturer has a dedicated web page for each of the food products they produce. These websites contain the product nutritional information in a human-readable format. Implementations of the present disclosure can extract this product nutritional information automatically using natural language processing and artificial intelligence techniques.

Alternatively or additionally, implementations of the present disclosure can include extracting the nutrition information based on applying ideas from computer vision to this specific natural language processing task. As a non-limiting example, implementations of the present disclosure can include using hierarchical models where the substrings containing the information for each nutrition item (e.g. calories) are modeled and detected separately, and the entire nutrition string model is constructed from the substring models. Moreover, implementations of the present disclosure can model each substring as a generative model, where the substring is reconstructed from the extracted interpretation to verify the accuracy of the interpretation.

An example implementation of the present disclosure was studied including a dataset of 2000 nutrition strings and their associated nutrition information values organized in a table. Half of this dataset can be used to train the different learning-based models, and the other half can be used for evaluating the models and the overall knowledge extraction algorithm. The proposed approach is based on the insights obtained while extracting the nutrition information semi-automatically from the nutrition strings and observing the challenges and the failure modes.

The United States is facing an obesity epidemic, and the obesity rate had increased from 30.5% in 2000 to 42.4% in 2018. Obesity is linked to many life-threatening conditions such as heart disease, stroke, type 2 diabetes, as well as certain types of cancer. The estimated annual cost of obesity in the US was $147 billion in 2008 dollars, placing a burden on the public and the government.

Fighting against the obesity epidemic can be done on multiple fronts. An important front is to educate the public on healthy eating principles, nutrition, and exercise. However, even when one is familiar with the healthy eating principles, it is still hard to implement them because it is hard to find the food products that meet these principles among the millions of food products available on the market.

When one desires to lose weight, one would like to search for foods that meet specific dietary needs, such as low calories, low carbs, low fat, high protein, or a combination of these criteria. Such a nutrition-restricted search is not desired only by people who want to lose weight. For example, vegetarians have a hard time finding plant-based food that is high in protein, and keto-dieters would like to find high fat and high protein food.

However, to accomplish this search in practice, one needs to go through many food products one by one and look at the nutrition information and find the one that best meets the desired criteria. This can be done, for example, at the supermarket by inspecting each food label visually. Such a comparative search is time-consuming and sub-optimal, being limited to the number of products available in the supermarket. Implementations of the present disclosure can make all this product information was available on a centralized website.

Implementations of the present disclosure include state-of-the-art knowledge extraction engines that are flexible enough to parse any product website and extract the nutrition information to store it in the database. Implementations of the present disclosure can use the constrained scope of input data (limited to nutrition information strings and pictures of nutrition information labels) to parse the websites, since most of the fields have only a small number of relevant words and with the nutrition values in a restricted range. There are many challenges though since the same information can be conveyed using different units of measure (e.g. grams, milligrams, or ounces), and there can be missing fields (e.g. missing information on Potassium) or extra text (e.g. describing how a serving is obtained) that is not needed to be entered in the data base.

While the example implementations described herein are configured for extracting nutritional information related to foods, it should be understood that this application is intended only as a non-limiting example. The implementations described herein can be configured to extract any other type(s) of product information from manufacturer websites and to construct other databases. Some non-limiting examples of data and product types that implementations can be configured for include: home appliances, power tools, or food in restaurants.

Knowledge Extraction Research

Implementations of the present disclosure can automatically extract from an input nutrition string the values associated with the different nutrition items such as calories, saturated fat, sodium, protein, etc., and adding them as a row in a database. Some examples of input nutrition strings are shown in FIG. 2.

It is possible that the input nutrition string can contain nutrition items that don't appear in the database in an example implementation of the present disclosure (e.g. strontium may not appear in an example implementation of the database). For that reason, only the items associated with the fields (columns) defined in the database need to be extracted. Given a number of field names, such as calories, saturated fat, sodium, protein, the example implementation can extract the associated values from the nutrition string, together with their units of measure. The extracted values can then be added as a row in a database, where the different field values can be placed at locations corresponding to the column names. This row can be associated with the input nutrition string, hence with the associated food product. Another task can be to associate the food product with a generic food category, such as pizza, hot dog, ice cream, chips, bread, etc. Any number of food categories can be used in some implementations, but an example implementation can include less than 100 food categories.

This categorization can allow the user to limit the search to a specific type of food for a more accurate search. An example of a method 300 of extracting the values from a nutrition string 302 and associating the food category is illustrated in FIG. 3. A database can include can include any number of column headers 304 representing different types of data that can be parsed from the string 302. The parsed data 306 is retrieved from the string 302, as shown in FIG. 3. In some implementations, the nutrition string 302 can be assigned a food category 310.

Extracting nutrition information from nutrition strings can be more restricted than the general problem of interpreting a sentence in natural language. However, it still poses many challenges to making it fully automatic. The nutrition strings can have a certain degree of variability, as shown in the examples in FIG. 2.

Non-limiting examples of challenges that can be found in some example nutrition strings include:
implied fields, e.g. “Nutrition Information Per ¼ Pizza (176 g)” means the “serving size” field has value 176 g.
varying name of units, e.g. pouch, bar, slice, chips, link, pieces, tsp, and varying units of measure, e.g. mL, g, mg, oz, %, etc.
extra information that needs to be ignored, e.g. “makes ½ cup” as in “Serving size ¼ package (22 g) (makes ½ cup)”
the location of the associated value can be before or after the field name, e.g. “3 servings per container” or “servings per container 6”
the field name in the nutrition string differs from the column name in the database. For example the database name is “total fat” but the field name in the nutrition string is “fat”.
missing fields e.g. missing servings per container information, extra fields, e.g. monounsaturated fat

The example systems and methods described herein can extract nutrition information from nutrition strings despite any or all of the above challenges, or any other challenges.

Knowledge Extraction Algorithm Overview

The knowledge extraction algorithm can extract from an input string containing nutrition information the values associated with the fields from the database, including the product brand and name.

Preprocessing. The first preprocessing step can include searching the nutrition string for keywords. A keyword is a substring associated with a nutrition field, and it could contain one or more words.

For example, a keyword associated with the ‘saturated fat’ field is ‘Saturated fat’, and another one is ‘Saturates’.

Some keywords are substrings of other keywords; for example, ‘fat’ is a substring of ‘saturated fat.’ The keywords that are uniquely associated with a single nutrition field are searched first; then the remaining keywords are searched in the space where no keywords have been detected already.

A dependency graph can be constructed, connecting the keywords with the database fields that they are associated with. The numerical values can be detected with their units of measure.

FIG. 4 illustrates an example dependency graph 400 for an example string 401, where the numerical values 402 can be connected to the adjacent keywords 404 before and after the numerical values 402, as illustrated in FIG. 4.

Of the substrings remaining after removing the detected keywords and values, one contains the product name. The rest are either unused strings or keywords for some unused fields (e.g., nutrition information for strontium, which is not database field in the present example). These remaining substrings can be connected in the dependency graph to the product name field.

The algorithm can find the most probable assignment of numerical values to keywords using dynamic programming.

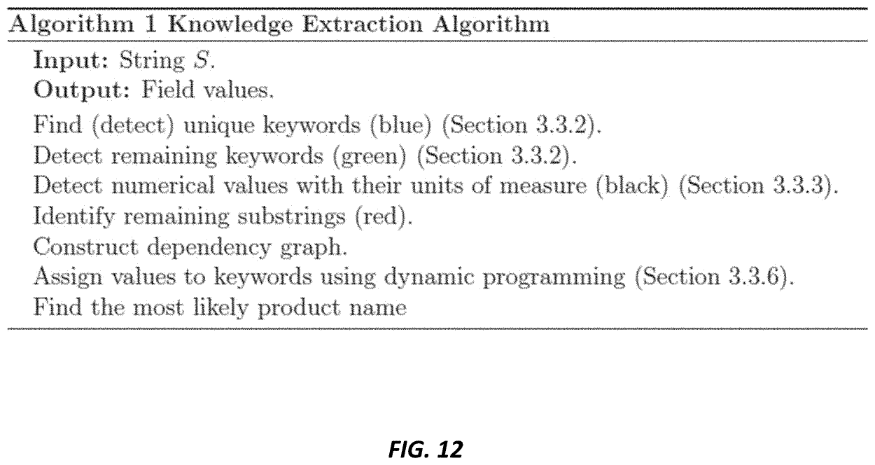

The most likely product name can be selected among the associated substrings by loss minimization. An example implementation of this process is further illustrated in FIG. 12.

FIG. 5 further illustrates how the model can divide a nutrition string into substrings associated with the fields of interest and include separate models for any/all of the substrings. FIG. 5 illustrates a string of text 500 divided into the following substrings: brand substring 502; product name substring 504; serving size substring 506; calories substring 508; and total fat substring 510. Additionally, it should be understood that the string of text 500 can include text that is not used or not relevant, which can be marked as unused text 512.

Keyword Detection

Implementations of the present disclosure can include different ways to search for keywords and use quantitative measures of accuracy to choose the most appropriate way. In some implementations, the method can include searching using standard string parsing methods. A more robust way can be to represent words and word sequences as vectors in a high dimensional space using the word2vec [9] algorithm and to search for keywords in the representation space using the Euclidean distance. For quantitative evaluation, a database of nutrition strings and their corresponding ground truth nutrition can be used.

Detection of Numerical Values

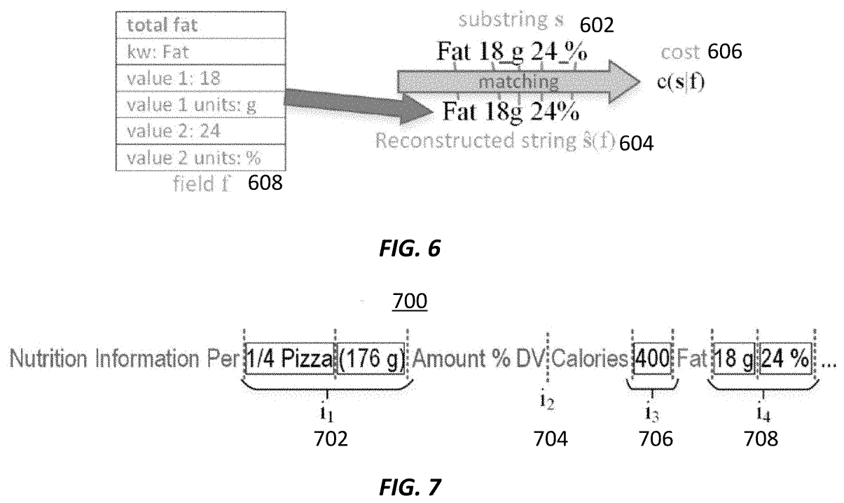

The numerical values can be detected by finding words containing the digits 0-9 and converting them to real numbers. The units of measure can be detected as the word immediately following the detected numerical value. The substring containing the detected numerical value and the unit of measure can be reconstructed from the extracted value and unit of measure, and the differences can be measured, as illustrated in FIG. 6 and described in more detail herein.

Implementations of the present disclosure can use quantitative methods to evaluate and guide configuring the algorithm for detecting the numerical values and the units of measure.

Hierarchical Model

To achieve a large degree of flexibility and accuracy, the nutrition string can be modeled using a hierarchical model where the entire string is modeled as the composition of the substrings associated with the different fields, and each substring can be governed by a model that quantifies its interpretation and how well its values have been extracted.

Let S be the input nutrition string and S_{i,j}, be the substring from position i to position j, where the position could be a character index or a word index. Word indices can be used for clarity and simplicity.

The interpretation of a substring is represented as ƒ=(x, w, v₁, m₁, . . . , vₖ, mₖ), where x is the index of the field in the database (e.g. x=4 corresponds to the ‘total fat’ field), w is the actual keyword used in the string (e.g. w=‘Fat’), and the rest are pairs (v, m) with v being the extracted value and m its unit of measure (e.g. v=4, m=‘g’). Usually k=≤2, since the values usually come as a quantity (with its unit of measure), which might be accompanied by its corresponding % of the daily value (which has ‘%’ as a unit of measure).

Given an array of indexes i=(i₁, . . . , iₙ) the string model divides the string into corresponding substrings and models each substring separately,

$$C ( f \vert S , i ) = c ( {f}_{1} \vert {S}_{0 , {i}_{1}} ) + c ( {f}_{2} \vert {S}_{{i}_{1} , {i}_{2}} ) + … + c ( {f}_{n} \vert {S}_{{i}_{n - 1} , {i}_{n}} ) = {\sum }_{k = 1}^{n} c ( {f}_{k} \vert {S}_{{i}_{k - 1} , {i}_{k}} ) , \qquad ( 1 )$$

where f=(ƒ₁, . . . , ƒₙ) are the extracted interpretations and iₒ=0. To accommodate extra strings that are not associated with any value, special interpretation can be added with index x=−1, which can be present multiple times in the string S. In contrast, the other indexes can only be present once.

The model has been presented as an energy model, but an equivalent probability model can be written for some implementations. The substring model c(f|S_{i,j}) is also described herein.

Building the Substring Model for Each Nutrition Field

The model c(f|s) defines the cost to relate an interpretation ƒ=(x, w, v₁, m₁, . . . , vk, mk) with a substring s. The present disclosure includes two non-limiting example model types: generative models and discriminative models.

The generative models can use the Bayes rule to write p(ƒ|s)∝p(s|ƒ)p(ƒ), which can be written in energy (cost) terms as c(f|s)=c(s|ƒ)+c(f), where c(s|ƒ) is the reconstruction cost for the substring s from the interpretation f, and c(ƒ) is a interpretation-specific cost (prior), modeling what kind of interpretations are more likely. The reconstruction cost c(s|ƒ)=d(ŝ(ƒ), s) can be based on obtaining a reconstruction Ŝ(ƒ) of the string from the interpretation f and measuring a distance to matching it with the original substring s, as illustrated in FIG. 6. FIG. 6 illustrates a substring s 602, a reconstructed substring Ŝ(ƒ) 604 and the cost c(s|ƒ) 606 for an example field 608.

Implementations of the present disclosure can include different types of distance functions c(ŝ(f), s). Non-limiting examples of distance functions include simple ones such as the earth movers distance, to parameterized distance functions based on different features extracted from the matching between ŝ(ƒ) and s.

The interpretation-specific cost c(ƒ) can be used to enforce some sanity checks and encourage the most probable positions of the numerical values relative to the keyword. First, it can make sure that the values are consistent, i.e., the value 2 (measured in % daily value) corresponds to the value 1 (with its unit of measure) based on standard nutrition guidelines. Second, it can make sure that the value 1 is within a range specific to that nutrition field, a range that has been observed in the training data. Each sanity check can be written as an additive term to c(f), and this term takes value 0 if the sanity check is satisfied, and a large value or ∞ otherwise. Other sanity checks can be used, such as checking how far is the field keyword w from a list of possible variants, e.g., w∈{‘fat’, ‘total fat’} for the ‘total fat’ field, or ‘saturated fat’, ‘saturates’ and ‘saturated’ for the ‘saturated fat’ field, etc. The position cost can associate different cost values (which need to be learned) to different positions of the numerical values relative to the keyword, where 0 means before the keyword, 1 means after, and 2 means the second location after the keyword. Again, the sanity checks described herein are intended only as non-limiting examples and other sanity checking systems and algorithms can be used in implementations of the present disclosure.

The generative models described herein can also be used to quantify the quality of the detection of the numerical values and their units of measure in a similar fashion.

The discriminative models are aimed at predicting c(f|s) directly; however they need more training examples than the generative models to train an accurate model. Assume again that the field is f=(x, w, v₁, m₁, vk, mk), with k≤2, where x is the field index, w is the actual keyword used, and vi is the i-th value associated with it with its unit of measure mi. Implementations described herein can train and evaluate discriminative classifiers to predict the field index x as a class out of the 20 possibilities (columns in the database). The discriminative classifier can output a score s (x|s) for any possible x (where a higher score means a more likely x).

To extract the values vᵢ associated with the field with their units of measure mᵢ, where the example implementation already has extracted the numerical values and the units of measure, as described herein and illustrated in FIG. 7. Only a few of these values uₗ, l=1, . . . , L reside inside the substring s. The example implementation can train binary classifiers to predict the correct value (which is one of the uₗ) as positive examples vs. the incorrect values as negatives. Let si(u) be the score obtained by the classifier for value i for the input u. Then the discriminative cost can be:

$$c ( f \vert s ) = - s ( x \vert s ) - {\sum }_{i = 1}^{k} {min}_{i} {s}_{i} ( {u}_{l} )$$

In some implementations, the discriminative model can be not as accurate as the generative model, since if a perfect reconstruction of the substring s is obtained from the parameter values of the field ƒ, this is can be a clear indication that the values in ƒ form a perfect explanation of s. For the discriminative models, there may be no such guarantees. Furthermore, there are many examples where classifiers are overconfident on data that is far away from the training examples [8], which means the classifier scores can be unreliable. However, it is a valid and important research question how do the generative models compare with discriminative models for the steps of knowledge extraction.

Two more models can be specified: the model for unused substrings and the model for the product name. Each unused substring s, which can be associated an interpretation u₅=(−1, s) can be associated a constant cost c(uₛ|s)=β, which can be a learnable parameter. The model for the product name can be based on the word2vec representation.

Building the Inference Algorithm for Knowledge Extraction

Given an input nutrition string S, the inference algorithm can search over the possible divisions i=into substrings and over interpretations f=(ƒ₁, . . . ƒₙ), where ƒᵢ is an interpretation of substring Sᵢ_{_{k−1}}_{,i}_{ₖ}, to minimize the total cost C(f|S, i) from eq. (1).

An exhaustive search for all the possible combinations can be a computationally prohibitive task. For that reason, implementations of the present disclosure can use a data-driven approach to limit the number of possibilities for i. For a fixed i, each term c(ƒₖ|Sᵢ_{_{k−1}}_{,i}_{ₖ}) of C(f|S, i) can be minimized independently.

Implementations of the present disclosure can use the detected keywords and numerical values to reduce the search space over the divisions i. The divisions iₖ can be placed between the detected values and keywords, with the divisions between two consecutive keywords grouped together, as illustrated in FIG. 7. Each group forms the possible values lₖ of iₖ for some k. FIG. 7 illustrates an example string 700 with four divisions: i₁ 702; i₂ 704; i₃ 706; i₄ 708.

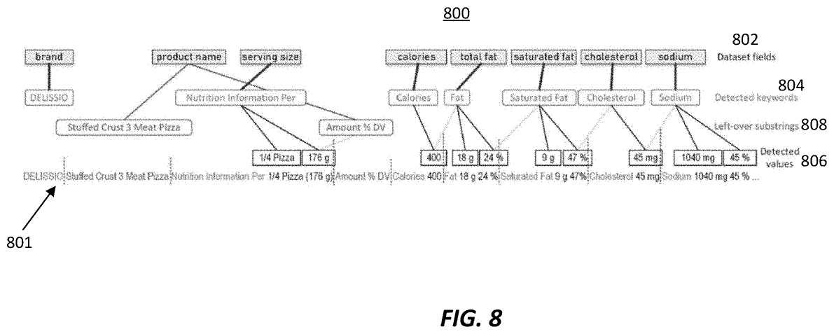

In some implementations, a well-constructed input string can have one keyword associated with each nutrition field, except for the product name, which can be associated with many unused keywords, as illustrated in FIG. 8. FIG. 8 illustrates a diagram 800 of a string 801 that has been parsed according to an example implementation to pair dataset fields 802 with detected keywords 804 and detected values 806. The left-over substrings 808 can also be separated. Under these assumptions, the product name can be found first by directly evaluating the costs for all substrings associated with it in the product graph and finding the substring with minimum cost. For any k and all combinations (i, j)∈|lₖ₋₁×lₖ, the substring costs c(ƒ|S_{i,j}) can be minimized and memorized as c_{i,j}^{k} together with the minimum cost interpretation ƒ_{i,j}^{k}.

The substrings containing the product name are associated with a high cost because they are irrelevant.

In some implementations, the global minimum can be obtained by dynamic programming by memorizing the partial Sums:

$${C}_{j}^{k} = {min}_{( {i}_{j} , … , {i}_{k} ) ∈ {I}_{1} \times … \times {I}_{k} , {i}_{k} = j} {\sum }_{i = 2}^{k} {c}_{{i}_{l - 1} , {i}_{l}}^{l}$$

Alternatively or additionally, recursively using the update equation:

$${C}_{j}^{k + 1} = {min}_{i ∈ {I}_{k}} ( {C}_{i}^{k} + {c}_{i , j}^{k + 1} ) \qquad ( 2 )$$

and the initial condition Cⱼ¹=0, ∀j∈l₁ cost is:

$${min}_{1 , f} C ( f \vert S , i ) = {min}_{j ∈ {I}_{n}} {C}_{j}^{n} .$$

In some implementations, the global minimum solution can obtained in the standard dynamic programming way, by finding the in E In that attains the minimum in (3) and tracing back recursively for k∈{n−1, . . . , 1} the iₖ∈lₖ that attains the minimum in (2) for j=iₖ₊₁. Having obtained the entire division sequence i, the associated minimum cost interpretation is obtained immediately as fk=f^{k}, where f^{k} is the memorized interpretation associated with c_{i,j}^{k}.

In some implementations of the present disclosure, the dynamic programming can be run to assign the values to the nutrition fields and finding the product name afterward from the unused substrings.

The model can be evaluated using examples (Sᵢ, fᵢ), i=1, . . . , N, where Sᵢ can be input nutrition strings and fᵢ the associated interpretations, which can be obtained semi-automatically using parsing scripts, then can be verified and corrected manually. In the example implementation described herein, 2000 such examples were obtained, of, as a non-limiting example 1000 can be used for training and 1000 can be used for evaluation. It should be understood that different proportions of training and evaluation data, as well as different numbers of examples, can be used in different implementations of the present disclosure.

The evaluation measures what percentage of all the interpretation components are correct, which can be a type of misclassification error. Let (S, f) be a training example, with f=(ƒ₁, . . . , ƒ_{d}), where d is the number of valid nutrition items and ƒᵢ=(xᵢ, wᵢ, vᵢ₁, mᵢ₁, . . . , vᵢₖ, mᵢₖ), with xᵢ in increasing order and unique, and let X={x₁, . . . , x_{d}}. Let \hat{f}=(\hat{ƒ}₁, . . . , \hat{ƒ}ₙ be the extracted interpretation, with n being the number of substrings and \hat{ƒ}ᵢ=(\hat{x}ᵢ, ŵᵢ, \hat{v}ᵢ₁, \hat{m}ᵢ₁, . . . , \hat{v}ᵢₗ, \hat{m}ᵢₗ), with \hat{x}i sorted in increasing order. Let \hat{X}={\hat{x}ᵢ, xᵢ<0} be the set of unique values of \hat{x}ᵢ>0. Let

$${e}_{i , j} = \frac{1}{3} [ δ ( {\hat{x}}_{i} = {x}_{j} ) + δ ( [ {\hat{v}}_{i 1} - {v}_{j 1} \vert < 0.01 {v}_{j 1} ) + δ ( {\hat{m}}_{j 1} = {m}_{j 1} ) ] , \\ i = \overline{1 , n} , j = \overline{1 , d} \qquad ( 4 )$$

where δ(Y) is 1 if Y is true, otherwise 0, and e_{i,-1}=δ(\hat{x}ᵢ=−1) Then the evaluation measure for this example can be:

$$E ( f , f ) = \vert \{ i , {x}_{i} = - 1 \} \vert + {\sum }_{i ∈ X ⋂ \hat{X}} {\sum }_{j , {\hat{x}}_{j} = e} {e}_{i , {j}_{i}} , \qquad ( 5 )$$

where j=(j₁, . . . , jₙ) is increasing.

The evaluation measure (5) can be averaged over all test examples to obtain the percentage of correct interpretations. Observe that the values vᵢ_{₁} can be assumed correct if they are within 1% of the original values.

Model Training

The model can be trained in a supervised manner using training examples (Sᵢ, fᵢ), i=1, . . . , N, where Sᵢ are input nutrition strings and fᵢ are the associated interpretations. As already mentioned, the example implementation can use N=1000 examples for training the initial model. When the dataset is expanded the model can be retrained with the additional data for better generalization. Training can be achieved by minimizing a loss function that is the average of a per-example loss function over the training examples:

$$ℒ = \frac{1}{N} {\sum }_{j = 1}^{N} L ( {f}_{j} , {\hat{f}}_{j} )$$

The per-example loss function L(f, \hat{f}) is a differentiable surrogate of the misclassification error (5):

$$L ( f , \hat{f} ) = \frac{1}{3 n} {\sum }_{i = 1}^{n} \vert ℓ ( {a}_{i} , {\hat{a}}_{i} ) + \frac{{‖ {v}_{i 1} - {\hat{v}}_{i 1} ‖}^{2}}{{‖ {v}_{i 1} ‖}^{2}} + ℓ ( {m}_{i 1} , {\hat{m}}_{i 1} ) \vert , \qquad ( 6 )$$

Where l(x, y) is a classification loss function such as the cross-entropy loss.

Data Collection

The knowledge extraction algorithms described herein can collect nutrition information from hundreds of thousands of food products from hundreds of manufacturers. As a non-limiting example, for each manufacturer, the example implementation can use Python scripts to retrieve the web pages referenced from the manufacturer's website and the knowledge extraction algorithm to extract the nutrition information if present. If the nutrition information is extracted successfully, the food product can be added to the database. Initially, the knowledge extraction algorithm can, in some implementations, have a lower degree of accuracy, and the output can, in those implementations be corrected manually. This can be because it was trained with a small amount of data, and it probably overfits this data. Each time a new manufacturer is added, some novel issues might arise regarding the string format, and the knowledge algorithm can sometimes have to be retrained. In some implementations of the present disclosure, the data collection and the knowledge algorithm training can be done together in several iterations to improve the accuracy over time. At each iteration, data from one or more manufacturers can be collected and verified. Novel issues with the knowledge extraction algorithm can be identified during the data verification, and then the algorithm can be retrained on all available data.

As more data is collected from more and more manufacturers, the retrained algorithm can have a good generalization, and fewer issues can arise. At that point, the algorithm can reach a level where it has high accuracy resulting in little if any human intervention.

Building a Food Category Predictor

This can include organizing the food products into a number, (e.g., less than 100 food categories). The actual food categories can be decided based on how the food products are organized in a regular supermarket. Some non-limiting food categories include pizza, pasta, hot dogs, ham, sausages, ice cream, etc. Alternatively or additionally, the example implementation can include a classifier that can automatically predict the food category for each food product. This can be a multi-class classification task. The input is the extracted nutrition information, including the product name and brand, and the output is the class label.

From the product name, the example implementation can, in some implementations, extract features using the bag of words approach. Each word from the name can be transformed into a feature vector using the word2vec [9] function. Then features can be computed as distances to the corresponding representations of some predefined words.

Additional non-limiting examples that can be used in implementations of the present disclosure include multi-class classifiers such as Support Vector Machines [10], Neural Networks, Boosted Decision Trees [4, 5] and Random Forests [2]. Feature selection [1, 6] can be employed to keep the relevant features and improve generalization.

Food Search Engine Deployment

Implementations of the present disclosure can make the food search engine available to the public to help them find the food products that meet their nutrition requirements.

The dataset can be accessed through a database (e.g., by SQL queries), and a web server can answer the user queries through a web interface 100 such as the one illustrated in FIG. 1. The interface can have a drop-down menu 102 for the food categories and can also have a text box 104 where the user can enter keywords that should be present in the product name or brand. The nutrition values can be restricted through several min or max boxes 105. What nutrition value(s) are to be restricted can be chosen from a drop-down menu (not shown).

The returned entries can be displayed as a table 110 and sorted by the desired field (e.g., by protein in decreasing order). FIG. 1 also illustrates an example section of a database 112 that can be queried.

Access to the food search engine can be unrestricted. Alternatively or additionally, it can be restricted by a quiz (e.g., a one question quiz) that can check the user for basic nutrition knowledge. If the user has answered the question correctly, they can be able to run queries on the food search engine; otherwise they can be delayed for several seconds or can be asked to answer another question.

Implementations of the present disclosure can also implement the capability for users to create an account and log in using their user name and password. Logged in users can be able to take a more thorough nutrition quiz to verify one and for all their nutrition knowledge. Logged in users who scored above a minimum threshold on this quiz can access the food search engine unrestricted.

Nutrition Education

Nutrition is taught in many countries, including the UK, in the United States, it is not a part of the universal curriculum. The lack of consistent nutrition education throughout the US can result in many areas where people are not familiar even with the most basic nutrition facts such as the importance of eating fruits and vegetables, the relation between red meat and colon cancer, etc. The lack of nutrition education is probably responsible, at least partly for the rise in obesity in the US.

Implementations of the present disclosure can be used for nutrition education. For example, implementations of the present disclosure can be used to educate the public about basic nutrition facts in an engaging and easy-to-follow manner, including using videos about different nutrition facts, with one fact per video. The videos can point to a website which can contain all the education materials about nutrition, organized by topics, and access to implementations of the present disclosure. Alternatively or additionally, the videos can be part of a curriculum.

Compiling the Nutrition Education Curriculum

The curriculum described herein can be broad enough to cover most of the important aspects of nutrition education. Additionally, the curriculum can be lean and only include the most important aspects to make it short and informative.

Building the Content for Nutrition Education Curriculum

Each of the nutrition education curriculum topics can be expanded as a web page with figures and diagrams illustrating the main concepts. Each topic can also contain a short quiz to verify how well the concepts have been learned. All the topics can be linked from a landing page that is an overview of the whole curriculum and its topics.

Building the Nutrition Education Videos

A short (e.g., 1-minute) video can also be made for each topic of the nutrition curriculum, consistent with the associate web page. The videos can be published on to make them attractive to different audiences (e.g, to a younger audience).

To evaluate the progress in familiarizing the public with the basic nutrition concepts, a quiz can be included before each search query containing a multiple-choice question or questions. The question can be selected at random from a large set of questions such as ‘What is one health problem related to eating too much sodium?’, ‘What is one benefit of eating fiber?’, etc., each with its possible correct answers. A correct answer can take the user directly to the food search interface. An incorrect answer can delay the user by several seconds before taking him to the interface. The percent of the questions that have been answered correctly by the users can be measured. A high percentage can mean that the users are familiar with the basic nutrition concepts.

### REFERENCES

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.
[1] Adrian Barbu, Yiyuan She, Liangjing Ding, and Gary Gramajo. Feature selection with annealing for computer vision and big data learning. IEEE transactions on pattern analysis and machine intelligence, 39(2):272-286, 2016.
[2] Leo Breiman. Random forests. Machine learning, 45(1):5-32, 2001.
[3] Tom B Brown, Benjamin Mann, Nick Ryder, Melanie Subbiah, Jared Kaplan, Prafulla Dhariwal, Arvind Neelakantan, Pranav Shyam, Girish Sastry, Amanda Askell, et al. Language models are few-shot learners. arXiv preprint arXiv:2005.14165, 2020.
[4] Tianqi Chen and Carlos Guestrin. Xgboost: A scalable tree boosting system. In Proceedings of the 22nd acm sigkdd international conference on knowledge discovery and data mining, pages 785-794, 2016.
[5] Gitesh Dawer, Yangzi Guo, and Adrian Barbu. Generating compact tree ensembles via annealing. In 2020 International Joint Conference on Neural Networks (IJCNN), pages 1-8. IEEE, 2020.
[6] Yangzi Guo, Yiyuan She, and Adrian Barbu. Training efficient network architecture and weights via direct sparsity control. In International Joint Conference on NeuralNetworks, 2021.
[7] Richard Andrew Harrington, Vyas Adhikari, Mike Rayner, and Peter Scarborough. Nutrient composition databases in the age of big data: fooddb, a comprehensive, real-time database infrastructure. BMJ open, 9(6):e026652, 2019.
[8] Matthias Hein, Maksym Andriushchenko, and Julian Bitterwolf. Why relu networks yield high-confidence predictions far away from the training data and how to mitigate the problem. In CVPR, pages 41-50, 2019.
[9] Tomas Mikolov, Kai Chen, Greg Corrado, and Jeffrey Dean. Efficient estimation of word representations in vector space. arXiv preprint arXiv:1301.3781, 2013.
[10] Vladimir Vapnik. The nature of statistical learning theory. Springer science & business media, 2013.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method, comprising:
extracting text data associated with a product, wherein the text data comprises a plurality of text strings;
detecting one or more keywords within the text strings;
detecting one or more numerical values within the text strings;
constructing, using a hierarchical model, a product-information record for the product from the one or more detected keywords and the one or more detected numerical values; and
storing the product-information record for the product in a data repository.

2. The method of claim 1, wherein the product is a food product.

3. The method of claim 1, wherein the text data comprises at least one of a product name, a product manufacturer, or a plurality of product attributes.

4. The method of claim 3, wherein the plurality of product attributes are nutritional attributes.

5. The method of claim 4, wherein the nutritional attributes comprise at least one of calories, total fat, saturated fat, sugar, sodium, or protein.

6. The method of claim 1, wherein the step of detecting the one or more keywords within the text strings comprises using a string parsing method.

7. The method of claim 1, wherein the step of detecting the one or more keywords within the text strings comprises representing the one or more keywords in a high-dimensional space and searching the high-dimensional space.

8. The method of claim 1, wherein the hierarchical model is a generative model.

9. The method of claim 1, wherein the hierarchical model is a discriminative model.

10. The method of claim 1, further comprising assigning, using dynamic programming, a respective numerical value to a respective keyword.

11. The method of claim 1, further comprising associating, using a classifier model, the product-information record for the product with one of a plurality of product categories.

12. The method of claim 11, wherein the classifier model is a support vector machine (SVM), an artificial neural network (ANN), a boosted decision tree (DT), or a random forest (RF).

13. The method of claim 1, wherein the text data is obtained from a product website.

14. The method of claim 1, wherein the text data is obtained from a product package using computer vision.

15. A method, comprising:
maintaining a data repository comprising a plurality of product-information records, wherein the data repository is created according to claim 1; and
querying the data repository for a product or a product attribute.

16. A system, comprising:
a processor; and
a memory operably coupled to the processor, the memory having computer-executable instructions stored thereon that, when executed by the processor, cause the processor to:
extract text data associated with a product, wherein the text data comprises a plurality of text strings;
detect one or more keywords within the text strings;
detect one or more numerical values within the text strings;
construct, using a hierarchical model, a product-information record for the product from the one or more detected keywords and the one or more detected numerical values; and
store the product-information record for the product in a data repository.

17. The system of claim 16, wherein the step of detecting the one or more keywords within the text strings comprises: using a string parsing method; or representing the one or more keywords in a high-dimensional space and searching the high-dimensional space.

18. The system of claim 16, wherein the hierarchical model is a generative model or a discriminative model.

19. The system of claim 16, wherein the memory has further computer-executable instructions stored thereon that, when executed by the processor, cause the processor to assign, using dynamic programming, a respective numerical value to a respective keyword.

20. The method of claim 16, wherein the memory has further computer-executable instructions stored thereon that, when executed by the processor, cause the processor to associate, using a classifier model, the product-information record for the product with one of a plurality of product categories.
